(19) United States
(12) Patent Application Publication
(10) Pub. No.: US 2017/0178206 A1
(43) Pub. Date: Jun. 22, 2017

(54) APPARATUS AND METHOD FOR CLASSIFYING PRODUCT TYPE

(71) Applicant: FOUNDATION OF SOONGSIL UNIVERSITY-INDUSTRY COOPERATION, Seoul (KR)

(72) Inventors: Soowon LEE, Seoul (KR); Sangkwon SIM, Seoul (KR)

(21) Appl. No.: 15/123,588

(22) PCT Filed: Jun. 15, 2016
(86) PCT No.: PCT/KR2016/006331

§ 371 Date: Sep. 2, 2016

(30) Foreign Application Priority Data
Aug. 10, 2015 (KR) 10-2015-0112253

(51) Int. Cl. G06Q 30/02; G06N 7/00

(52) U.S. Cl. CPC G06Q 30/0282; G06N 7/005

(57) ABSTRACT

Disclosed are an apparatus and method for classifying a product type. The apparatus for classifying the product type calculates a utilitarian and hedonic index, a word similarity, or an emotion index which is an objective index capable of determining a type of a product using a word that appears in reviews of the product, and classifies the type of a corresponding product using the calculated utilitarian and hedonic index, word similarity, or emotion index.

### BACKGROUND

Field of the Invention

The present invention relates to an apparatus and method for classifying a product type, and more particularly, to an apparatus and method for classifying a product type that may analyze and classify a type of a corresponding product.

Discussion of Related Art

Online shopping has developed into a very critical information search media as products are purchased, providing easy information acquisition for products as well as increasing purchasing convenience of consumers. In addition, new media channels such as online communities, review sites, social network services, and the like are used by more consumers to express their views and transmit product information.

Meanwhile, according to a consumer behavior theory which is involved in one of social science fields, product purchase motives of consumers may be classified as a utilitarian motive or a hedonic motive. The former is a motive to obtain utilitarian utility by consuming a product and the latter is a motive to obtain pleasure by consuming a product. For example, in a case in which a main motive for purchasing a washing machine is the utilitarian motive, washing performance, a degree in which laundry is tangled, and the like may be considered as important evaluation criteria, but in a case in which the main motive for purchasing the washing machine is the hedonic motive, a design or appearance of the washing machine may be relatively emphasized. Accordingly, it is possible to classify types of the products as a utilitarian product type and a hedonic product type according to consumer behavior theory.

Product type classification is very important in the field of marketing in which product information and values should be transmitted to consumers within a limited time because it affects the information processing process of the consumers. However, an existing method for classifying the type of a product uses a method in which a marketer arbitrarily allocates the type of the product according to features of corresponding products, and therefore is problematic in that the existing method is not objective because the type of a product may vary for each marketer and a type of product recognized by consumers is difficult to be determined.

Therefore, there is a demand for a method for classifying the type of a product using objective numeric values.

### SUMMARY OF THE INVENTION

The present invention is directed to an apparatus and method for classifying a product type that may calculate an objective numeric value through which a type of a product can be determined using words included in reviews of the corresponding product, and classify the type of the corresponding product using the calculated objective numeric value.

According to an aspect of the present invention, there is provided a method for classifying a product type including: collecting reviews of a product to be classified; extracting a word from the reviews and calculating an appearance frequency of the word; calculating a utilitarian and hedonic index, a word similarity, or an emotion index for the product to be classified using the appearance frequency of the word; and classifying a type of the product to be classified according to the utilitarian and hedonic index, the word similarity, or the emotion index for the product to be classified.

Here, the calculating of the utilitarian and hedonic index for the product to be classified may include detecting a word utilitarian and hedonic index corresponding to the word from a utilitarian/hedonic dictionary established in advance, and calculating the utilitarian and hedonic index for the product to be classified using the detected word utilitarian and hedonic index and the appearance frequency of the word.

Also, the calculating of the utilitarian and hedonic index for the product to be classified using the detected word utilitarian and hedonic index and the appearance frequency of the word may include extracting a plurality of words from the reviews, calculating an appearance frequency of each of the plurality of words extracted from the reviews, detecting a word utilitarian and hedonic index corresponding to each of the plurality of words, and calculating the appearance frequency of each of the plurality of words and a weighted average of the word utilitarian and hedonic index corresponding to each of the plurality of words, thereby calculating the utilitarian and hedonic index for the product to be classified.

Also, the classifying of the type of the product to be classified according to the utilitarian and hedonic index for the product to be classified may include classifying the product to be classified as a utilitarian product when the utilitarian and hedonic index for the product to be classified exceeds a predetermined threshold value, and classifying the product to be classified as a hedonic product when the utilitarian and hedonic index for the product to be classified is the predetermined threshold value or less.

Also, the calculating of the word similarity for the product to be classified may include generating a word frequency vector of the product to be classified that is configured with the appearance frequency of the word, calculating a cosine similarity between the word frequency vector of the product to be classified and a word frequency vector of a utilitarian product trained in advance, and calculating a cosine similarity between the word frequency vector of the product to be classified and a word frequency vector of a hedonic product trained in advance.

Also, the classifying of the type of the product to be classified according to the word similarity for the product to be classified may include classifying the product to be classified as a utilitarian product when the cosine similarity between the word frequency vector of the product to be classified and the word frequency vector of the utilitarian product trained in advance is larger than the cosine similarity between the word frequency vector of the product to be classified and the word frequency vector of the hedonic product trained in advance, and classifying the product to be classified as a hedonic product when the cosine similarity between the word frequency vector of the product to be classified and the word frequency vector of the utilitarian product trained in advance is less than the cosine similarity between the word frequency vector of the product to be classified and the word frequency vector of the hedonic product trained in advance.

Also, the calculating of the emotion index for the product to be classified may include detecting an emotion category to which the word belongs, detecting a use probability for each emotion category of the word from use probability data for each emotion category stored in advance, detecting an emotional strength corresponding to the emotion category of the word from emotional strength data for each emotion category stored in advance, correcting the emotional strength corresponding to the emotion category of the word using the use probability for each emotion category of the word, and calculating the emotion index for the product to be classified using the corrected the emotional strength.

Also, the calculating of the emotion index for the product to be classified using the corrected emotional strength may include calculating the corrected emotional strength, the appearance frequency for each emotion category of the word, and a weighted average of the use probability for each emotion category of the word, thereby calculating the emotion index for the product to be classified.

Also, the classifying of the type of the product to be classified using the emotion index for the product to be classified may include collecting reviews for a plurality of products, generating training data capable of classifying the type of the product to be classified according to the emotion index through machine learning on the collected reviews for the plurality of products, and applying the emotion index for the product to be classified to the training data, thereby classifying the type of the product to be classified.

Also, the method for classifying a product type may further include detecting a domain to which the product to be classified belongs, detecting feature combination information corresponding to the domain to which the product to be classified belongs from feature combination data for each domain stored in advance, generating a classification model for the product to be classified according to the detected feature combination information, and classifying the type of the product to be classified using the classification model for the product to be classified.

Also, the extracting of a word from the reviews and calculating an appearance frequency of the word that appears in the reviews may include correcting the appearance frequency of the word using a ratio of the number of times the word appears in the reviews to the number of all words that appear in the reviews in order to minimize an error factor caused by a difference in the number of words that appear in reviews of a utilitarian product and a hedonic product.

According to another aspect of the present invention, there is provided an apparatus for classifying a product type including: a collection unit that collects reviews of a product to be classified; a pre-processing unit that extracts a word from the reviews and calculates an appearance frequency of the word; and a classification unit that calculates a utilitarian and hedonic index, a word similarity, or an emotion index for the product to be classified using the appearance frequency of the word, and classifies a type of the product to be classified according to the utilitarian and hedonic index, the word similarity, or the emotion index for the product to be classified.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a product type classification apparatus according to an embodiment of the present invention;

FIG. 2 is a graph illustrating a classification accuracy result for each training algorithm;

FIG. 3 is a flowchart illustrating a product type classification method using a utilitarian and hedonic index according to an embodiment of the present invention;

FIG. 4 is a flowchart illustrating a product type classification method using a utilitarian and hedonic index according to another embodiment of the present invention;

FIG. 5 is a flowchart illustrating a product type classification method using word similarity according to an embodiment of the present invention;

FIG. 6 is a flowchart illustrating a product type classification method using word similarity according to another embodiment of the present invention;

FIG. 7 is a flowchart illustrating a product type classification method using an emotion index according to an embodiment of the present invention; and

FIG. 8 is a flowchart illustrating a product type classification method using a combination of features according to an embodiment of the present invention.

### REFERENCE NUMERALS

1: product type classification apparatus
100: collection unit
200: pre-processing unit
300: classification unit
310: utilitarian and hedonic index calculation unit
320: word similarity calculation unit
330: emotion index calculation unit
340: feature combination unit
350: product type classification unit

### DETAILED DESCRIPTION OF EXEMPLARY EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It should be understood that the various embodiments of the invention, although different, are not necessarily mutually exclusive. For example, a particular feature, structure, or characteristic described herein in connection with one embodiment may be implemented within other embodiments without departing from the spirit and scope of the present invention. Also, it should be understood that the positions or arrangements of individual elements in the embodiment may be changed without deviating from the spirit and scope of the present invention. The following detailed description is, therefore, not to be taken in a limiting sense, and the scope of the present invention is defined only by the appended claims that should be appropriately interpreted along with the full range of equivalents to which the claims are entitled. In the drawings, like reference numerals identify like or similar elements or functions through several views.

Hereinafter, preferred embodiments of the present invention will be described in detail with reference to the accompanying drawings.

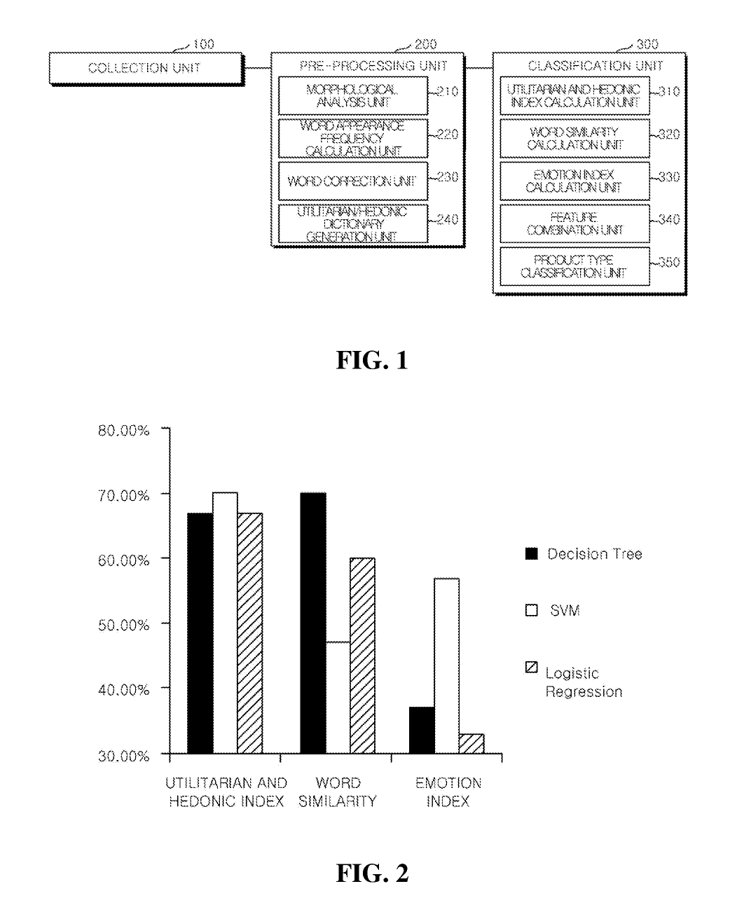

FIG. 1 is a block diagram illustrating a product type classification apparatus according to an embodiment of the present invention, and FIG. 2 is a graph illustrating a classification accuracy result for each learning algorithm.

A product type classification apparatus 1 according to an embodiment of the present invention may collect reviews for a product, analyze words included in the reviews, and classify types of a corresponding product. At this point, classifying types of a product may refer to classifying a corresponding product as either a utilitarian product or a hedonic product.

Referring to FIG. 1, the product type classification apparatus 1 according to an embodiment of the present invention may include a collection unit 100, a pre-processing unit 200, and a classification unit 300.

The collection unit 100 may collect reviews for a corresponding product from online communities, shopping malls, or the like. At this point, the collection unit 100 may collect the reviews for the corresponding product by matching the collected reviews with a product name or specification information which is recorded concerning the corresponding product.

The pre-processing unit 200 may analyze the reviews collected by the collection unit 100 and extract words that appear frequently in the reviews. To this end, the pre-processing unit 200 may include a morphological analysis unit 210 and a word appearance frequency calculation unit 220.

The morphological analysis unit 210 may morphologically analyze the reviews collected by the collection unit 100 in units of sentences, and extract nouns, verbs, and adjectives for the corresponding product from the collected reviews.

The word appearance frequency calculation unit 220 may extract frequently occurring words from sentences which have been subjected to morphological analysis by the morphological analysis unit 210. At this point, when it is determined that a predetermined number of arbitrary words or more appear in the reviews, the word appearance frequency calculation unit 220 may recognize the corresponding words as frequently occurring words. The word appearance frequency calculation unit 220 may calculate an appearance frequency of a corresponding word by detecting the number of times that an arbitrary frequently occurring word appears in the reviews.

Meanwhile, since the number of words that appear in reviews of a utilitarian product is relatively larger than the number of words that appear in reviews of a hedonic product (median value of the number of the words of a utilitarian product: 10.62, median value of the number of the words of a hedonic product: 9.74), that is, since the number of reviews for a utilitarian product is larger than the number of reviews for a hedonic product, the words that appear in the reviews of a utilitarian product may appear at a relatively higher frequency compared to a hedonic product when simply using an appearance frequency of the corresponding word. The product type classification apparatus 1 according to another embodiment of the present invention may classify types of products using the appearance frequency of a corresponding word, but when simply using only the appearance frequency of the corresponding word as described above, a utilitarian product may have a relatively higher appearance frequency than that of a hedonic product so that it is impossible to accurately classify the types of products. Accordingly, the pre-processing unit 200 according to another embodiment of the present invention may include a word correction unit 230 in order to solve the above-described problem.

The word correction unit 230 may correct frequently occurring words included in corresponding reviews in order to normalize the number of reviews of each of the utilitarian product and the hedonic product.

Specifically, the word correction unit 230 may calculate a ratio of an appearance frequency of an arbitrary frequently occurring word to an appearance frequency of total words that appear in a single review, thereby normalizing the number of the corresponding reviews. The appearance frequency of the corrected arbitrary frequently occurring word may be calculated by the following Equation 1.

$${f}^{′} ( {ω}_{i} ) = {\sum }_{r ∈ R} \frac{{f}_{r} ( {ω}_{i} )}{{\sum }_{i} {f}_{r} ( {ω}_{i} )} \qquad [ Equation 1 ]$$

Here, f′(ωᵢ) denotes an appearance frequency of the corrected word for a word ωᵢ, and fᵣ(ωᵢ) denotes an appearance frequency of the word ωᵢ for a review r.

The pre-processing unit 200 according to an embodiment of the present invention may generate a utilitarian/hedonic dictionary in order to classify types of products using the appearance frequency of a corresponding word. To this end, the pre-processing unit 200 may include a utilitarian/hedonic dictionary generation unit 240.

The utilitarian/hedonic dictionary generation unit 240 may generate the utilitarian/hedonic dictionary by calculating a utilitarian and hedonic index of a word included in the reviews of each of the utilitarian product and the hedonic product.

Specifically, the utilitarian/hedonic dictionary generation unit 240 may collect the reviews of each of the utilitarian product and the hedonic product through the collection unit 100. The utilitarian/hedonic dictionary generation unit 240 may extract a word or a frequently occurring word from the collected reviews of each of the utilitarian product and the hedonic product. The utilitarian/hedonic dictionary generation unit 240 may calculate the number of times that an arbitrary word extracted from the reviews of the utilitarian product appears in the reviews of the utilitarian product. The utilitarian/hedonic dictionary generation unit 240 may calculate a total appearance frequency of a plurality of words that appear in the reviews of the utilitarian product. The utilitarian/hedonic dictionary generation unit 240 may calculate a probability P(Utlitarian|ωᵢ) that an arbitrary word ωᵢ will appear in reviews of a utilitarian product using a ratio of the number of times that the arbitrary word appears in the reviews of the utilitarian product to the total appearance frequency of the plurality of words that appear in the reviews of the utilitarian product. The utilitarian/hedonic dictionary generation unit 240 may calculate the number of times that an arbitrary word extracted from the reviews of the hedonic product appears in the reviews of the hedonic product. The utilitarian/hedonic dictionary generation unit 240 may calculate a total appearance frequency of a plurality of words that appear in the reviews of the hedonic product. The utilitarian/hedonic dictionary generation unit 240 may calculate a probability P(Hedonic|ωᵢ) that the arbitrary word ωᵢ will appear in reviews of a hedonic product using a ratio of the number of times that the arbitrary word appears in the reviews of the hedonic product to the total appearance frequency of the plurality of words that appear in the reviews of the hedonic product. The utilitarian/hedonic dictionary generation unit 240 may calculate a utilitarian and hedonic index of the word ωᵢ using the calculated probability P(Utlitarian|ωᵢ) that the arbitrary word ωᵢ will appear in reviews of a utilitarian product and the calculated P(Hedonic|ωᵢ) that the arbitrary word ωᵢ appears in the reviews of the hedonic product. At this point, the utilitarian and hedonic index of the arbitrary word ωᵢ may be calculated through the following Equation 2.

$$\begin{matrix}UH - Score ( {ω}_{i} ) = P ( Utilitarian \text{\textbar} {ω}_{i} ) - P ( Hedonic \text{\textbar} {ω}_{i} ) \\ = \frac{f ( {ω}_{i} \text{\textbar} Utilitarian ) - f ( {ω}_{i} \text{\textbar} Hedonic )}{f ( {ω}_{i} \text{\textbar} Utilitarian ) + f ( {ω}_{i} \text{\textbar} Hedonic )}\end{matrix} \qquad [ Equation 2 ]$$

Here, UH−Score(ωᵢ) denotes the utilitarian and hedonic index of the arbitrary word ωᵢ, P(Utlitarian|ωᵢ) denotes a probability that the arbitrary word ωᵢ will appear in reviews of a utilitarian product, P(Hedonic|ωᵢ) denotes a probability that arbitrary word ωᵢ will appear in reviews of a hedonic product, f(ωᵢ|Utilitarian) denotes an appearance frequency of the arbitrary word ωᵢ in the reviews of the utilitarian product, and f(ωᵢ|Hedonic) denotes an appearance frequency of the arbitrary word ωᵢ in the reviews of the hedonic product.

The utilitarian/hedonic dictionary generation unit 240 may respectively calculate and store the utilitarian and hedonic indexes of words included in the reviews of the utilitarian product and the hedonic product as described above, thereby generating the utilitarian/hedonic dictionary. An example of the generated utilitarian/hedonic dictionary is shown in the following Table 1.

TABLE 1

| | | Appearance | Appearance | |
|---|---|---|---|---|
| | | frequency in | frequency in | |
| Classifi- | | reviews of utili- | reviews of he- | UH − |
| cation | words | tarian product | donic product | Score(ωᵢ) |
| Five | Driving | 112 | 1 | 0.982 |
| words of | Hybrid | 273 | 3 | 0.978 |
| utilitarian | Fuel | 368 | 6 | 0.968 |
| | efficiency | | | |
| product | Battery | 51 | 1 | 0.962 |
| | Design | 154 | 4 | 0.949 |
| Five | Installment | 35 | 110 | −0.517 |
| words of | Germany | 10 | 67 | −0.740 |
| hedonic | Promotion | 3 | 23 | −0.769 |
| product | Europe | 2 | 38 | −0.900 |

The utilitarian/hedonic dictionary generation unit 240 according to another embodiment of the present invention may generate a utilitarian/hedonic dictionary using an appearance frequency corrected by the word correction unit 230.

Specifically, the utilitarian/hedonic dictionary generation unit 240 may collect the reviews of the utilitarian product and the reviews of the hedonic product through the collection unit 100. The utilitarian/hedonic dictionary generation unit 240 may extract an arbitrary word from the collected reviews of each of the utilitarian product and the hedonic product. The utilitarian/hedonic dictionary generation unit 240 may calculate the number of times that the arbitrary word extracted from the reviews of the utilitarian product appears in the reviews of the utilitarian product. The utilitarian/hedonic dictionary generation unit 240 may calculate the corrected appearance frequency of the arbitrary word through the word correction unit 230. The utilitarian/hedonic dictionary generation unit 240 may calculate an appearance frequency of each of a plurality of corrected words that appear in the reviews of the utilitarian product. The utilitarian/hedonic dictionary generation unit 240 may calculate a probability P′(Utlitarian|ωᵢ) that an arbitrary corrected word ωᵢ will appear in reviews of a utilitarian product using a ratio of the appearance frequency of the arbitrary corrected word to the appearance frequency of each of the plurality of corrected words that appear in the reviews of the utilitarian product. The utilitarian/hedonic dictionary generation unit 240 may calculate an appearance frequency of an arbitrary corrected word which is extracted from the reviews of the hedonic product. The utilitarian/hedonic dictionary generation unit 240 may calculate an appearance frequency of each of a plurality of corrected words that appear in the reviews of the hedonic product. The utilitarian/hedonic dictionary generation unit 240 may calculate a probability P′(Hedonic|ωᵢ) that the arbitrary corrected word ωᵢ will appear in reviews of a hedonic product using a ratio of the appearance frequency of the arbitrary corrected word to the appearance frequency of each of the plurality of corrected words that appear in the reviews of the hedonic product. The utilitarian/hedonic dictionary generation unit 240 may calculate a utilitarian and hedonic index of the arbitrary corrected word ωᵢ using the calculated probability P′(Utlitarian|ωᵢ) that the arbitrary corrected word ωᵢ will appear in reviews of a utilitarian product and the calculated probability P′(Hedonic|ωᵢ) that the arbitrary corrected word ωᵢ will appear in reviews of a hedonic product. At this point, the utilitarian and hedonic index of the arbitrary corrected word ωᵢ may be calculated through the following Equation 3.

$$UH - {Score}^{′} ( {ω}_{i} ) = \frac{{f}^{′} ( {ω}_{i} \text{\textbar} Utilitarian ) - f ( {ω}_{i} \text{\textbar} Hedonic )}{{f}^{′} ( {ω}_{i} \text{\textbar} Utilitarian ) + f ( {ω}_{i} \text{\textbar} Hedonic )} \qquad [ Equation 3 ]$$

Here, UH−Score′(ωᵢ) denotes the utilitarian and hedonic index of the arbitrary corrected word ωᵢ, f′(ωᵢ|Utilitarian) denotes an appearance frequency of the arbitrary corrected word ωᵢ in the reviews of the utilitarian product, f′(ωᵢ|Hedonic) denotes an appearance frequency of the arbitrary corrected word ωᵢ in the reviews of the hedonic product, f(ωᵢ|Utilitarian) denotes an appearance frequency of the arbitrary word ωᵢ in the reviews of the utilitarian product, and f(ωᵢ|Hedonic) denotes an appearance frequency of the arbitrary word ωᵢ in the reviews of the hedonic product.

Meanwhile, the calculated utilitarian and hedonic index of the word may have a value of −1.0 to 1.0, and therefore the word may be recognized as a utilitarian word as its utilitarian and hedonic index is close to 1.0 and recognized as a hedonic word as its utilitarian and hedonic index is close to −1.0. That is, when the utilitarian and hedonic index of the word is larger than 0 (>0), the corresponding word may be recognized as a utilitarian word, and when the utilitarian and hedonic index of the word is 0 or less, the corresponding word may be recognized as a hedonic word.

The classification unit 300 may classify the type of the corresponding product by analyzing an appearance frequency of each word that appears in reviews of the corresponding product. To this end, the classification unit 300 may include a utilitarian and hedonic index calculation unit 310 and a product type classification unit 350.

The utilitarian and hedonic index calculation unit 310 may calculate a utilitarian and hedonic index of a product to be classified using the appearance frequency of each word included in reviews of the product to be classified and a utilitarian/hedonic dictionary generated in advance.

Specifically, the utilitarian and hedonic index calculation unit 310 may extract the words that appear in the reviews of the product to be classified through the pre-processing unit 200. The utilitarian and hedonic index calculation unit 310 may calculate the appearance frequency of each of the words that appear in the reviews of the product to be classified through the pre-processing unit 200. The utilitarian and hedonic index calculation unit 310 may calculate a utilitarian and hedonic index corresponding to each of words that appear in the reviews of the product to be classified from the utilitarian/hedonic dictionary generated in advance. The utilitarian and hedonic index calculation unit 310 may calculate a utilitarian and hedonic index of the product to be classified using the appearance frequency of each of a plurality of words that appear in the reviews of the product to be classified and the utilitarian and hedonic index of each of the words. At this point, the utilitarian and hedonic index of the product to be classified may be calculated by the following Equation 4.

$$UH - {Score}_{product} ( p ) = \frac{{\sum }_{i = 1}^{W ( p )} f ( p , {ω}_{i} ) \times UH - Score ( {ω}_{i} )}{{\sum }_{i = 1}^{W ( p )} f ( p , {ω}_{i} )} \qquad [ Equation 4 ]$$

Here, UH−Score_{product}(p) denotes a utilitarian and hedonic index of a product p, W(p) denotes a set of words that appear in reviews of the product p, f(p,ωᵢ) denotes an appearance frequency of a word ωᵢ in the reviews of the product p, and UH−Score(ωᵢ) denotes a utilitarian and hedonic index of the word ωᵢ.

The utilitarian and hedonic index calculation unit 310 according to another embodiment of the present invention may calculate a utilitarian and hedonic index of a product to be classified according to frequency correction using an appearance frequency of a word whose appearance frequency has been corrected, in order to prevent the type of a product from being wrongly classified due to the number of the reviews of the utilitarian product or the hedonic product.

Specifically, the utilitarian and hedonic index calculation unit 310 according to another embodiment of the present invention may extract words that appear in reviews of a product to be classified through the pre-processing unit 200. The utilitarian and hedonic index calculation unit 310 may calculate an appearance frequency of each of the words that appear in the reviews of the product to be classified through the pre-processing unit 200. The utilitarian and hedonic index calculation unit 310 may calculate a corrected appearance frequency of each of the words that appear in the reviews of the product to be classified through the word correction unit 230. The utilitarian and hedonic index calculation unit 310 may calculate a corrected utilitarian and hedonic index UH−Score′(ωᵢ) corresponding to each of the words that appear in the reviews of the product to be classified from a utilitarian/hedonic dictionary generated in advance. The utilitarian and hedonic index calculation unit 310 may calculate the corrected utilitarian and hedonic index of the product to be classified using the corrected appearance frequency of each of the plurality of words that appear in the reviews of the product to be classified and the corrected utilitarian and hedonic index of each of the words. At this point, the corrected utilitarian and hedonic index of the product to be classified may be calculated by the following Equation 5.

$$UH - {Score}_{product}^{′} ( p ) = \frac{{\sum }_{i = 1}^{W ( p )} {f}^{′} ( p , {ω}_{i} ) \times UH - {Score}^{′} ( {ω}_{i} )}{{\sum }_{i = 1}^{W ( p )} {f}^{′} ( p , {ω}_{i} )} \qquad [ Equation 5 ]$$

Here, UH−Score_{product}′(p) denotes a utilitarian and hedonic index of a product p which has been calculated using the appearance frequency of the corrected word, W(p) denotes a set of the words that appear in the reviews of the product p, f′(p,ωᵢ) denotes a corrected appearance frequency of a word ωᵢ in the reviews of the product p, and UH−Score′(ωᵢ) denotes a utilitarian and hedonic index of the word ωᵢ whose appearance frequency is corrected.

The product type classification unit 350 may classify the type of the product to be classified according to the utilitarian and hedonic index of the product to be classified which has been calculated by the utilitarian and hedonic index calculation unit 310. When the utilitarian and hedonic index of the product to be classified which has been calculated by the utilitarian and hedonic index calculation unit 310 is larger than 0 (>0), the product type classification unit 350 may classify the type of the product to be classified as a utilitarian product. When the utilitarian and hedonic index of the product to be classified which has been calculated by the utilitarian and hedonic index calculation unit 310 is 0 or less, the product type classification unit 350 may classify the type of the product to be classified as a hedonic product.

An example of comparing the utilitarian and hedonic index of the product to be classified which has been calculated using a non-corrected appearance frequency of a corresponding word and the utilitarian and hedonic index of the product to be classified which has been calculated using a corrected appearance frequency of the corresponding word is shown in the following Table 2. From Table 2, it can be seen that most products have a difference between the utilitarian and hedonic index of the product to be classified which has been calculated using the non-corrected appearance frequency of the corresponding word and the utilitarian and hedonic index of the product to be classified which has been calculated using the corrected appearance frequency of the corresponding word, and types of some of the products are classified differently due to the correction of the appearance frequency of the corresponding word.

TABLE 2

| Classifi- | | UH − | UH − |
|---|---|---|---|
| cation | Product name | Score_{product}(p) | Score_{product}′(p) |
| Utilitarian | Spark | 0.161 | 0.161 |
| product | Sonata Hybrid | 0.127 | 0.031 |
| | Carnival | 0.095 | −0.045 |
| Hedonic | Genesis coupe | −0.037 | −0.202 |
| product | Audi R8 | −0.040 | −0.228 |
| | Fiat 500 | −0.009 | −0.161 |

Here, the classification unit 300 according to another embodiment of the present invention may classify the type of a product to be classified by calculating a similarity between a word vector trained for each product type and a word vector of the product to be classified. To this end, the classification unit 300 according to another embodiment of the present invention may include a word similarity calculation unit 320 and a product type classification unit 350. The word similarity calculation unit 320 may calculate an appearance frequency of each of a plurality of words that appear in reviews of the product to be classified through the word appearance frequency calculation unit 220. The word similarity calculation unit 320 may generate a word vector of the product to be classified that has been configured with the appearance frequencies of the plurality of words that appear in the reviews of the product to be classified. The word similarity calculation unit 320 may calculate a similarity between a word vector trained for each product type and the word vector of the product to be classified. At this point, the word vector of the product to be classified and the trained word vector may be shown in the following Equation 6.

\vec{Util}=(f^{Util}(ω₁),f^{Util}(ω₂), . . . ,f^{Util}(ωₙ)),ωᵢ={ωᵢεWᵤₜᵢₗ},i=1, . . . n

\vec{Hed}=(f^{Hed}(ω₁),f^{Hed}(ω₂), . . . ,f^{Hed}(ωₙ)),ωᵢ={ωᵢεW_{hed}},i=1, . . . n

\vec{p}=(f(p,ω₁),f(p,ω₂), . . . ,f(p,ωₙ)),ωᵢ={ωᵢεW(p)},i=1, . . . n [Equation 6]

Here, \vec{Util} denotes a frequency vector of words that appear in the reviews of the utilitarian product, \vec{Hed} denotes a frequency vector of words that appear in the reviews of the hedonic product, \vec{p} denotes a frequency vector of words that appear in the reviews of the product p to be classified, f^{util}(ωᵢ) denotes an appearance frequency of a word ωᵢ in the reviews of the utilitarian product, f^{Hed}(ωᵢ) denotes an appearance frequency of the word ωᵢ in the reviews of the hedonic product, f(p,ωᵢ) denotes an appearance frequency of the word ωᵢ in the reviews of a product to be classified p, Wᵤₜᵢₗ denotes a set of the words that appear in the reviews of the utilitarian product, W_{hed} denotes a set of the words that appear in the reviews of the hedonic product, and W(p) denotes a set of the words that appear in the reviews of the product to be classified p.

Meanwhile, the calculating of the similarity between the word vector trained for each product type and the word vector of the product to be classified may calculate a cosine similarity between the word vector trained for each product type and the word vector of the product to be classified.

Meanwhile, a word vector trained for each product type may refer to a frequency vector of the words that appear in the reviews of the utilitarian product and a frequency vector of the words that appear in the reviews of the hedonic product.

The product type classification unit 350 may classify the type of the product to be classified according to the similarity between the word vector trained for each product type and the word vector of the product to be classified that has been calculated by the word similarity calculation unit 320. At this point, the product type classification unit 350 may calculate a word similarity between the frequency vector \vec{Util} of the words that appear in the reviews of the utilitarian product and the word vector \vec{p} of the product to be classified. In addition, the product type classification unit 350 may calculate a word similarity between the frequency vector \vec{Hed} of the words that appear in the reviews of the hedonic product and the word vector \vec{p} of the product to be classified. The product type classification unit 350 may classify the type of the product to be classified as a type having a high similarity with the word vector \vec{p} of the product to be classified from either the word similarity between the frequency vector \vec{Util} of the words that appear in the reviews of the utilitarian product and the word vector \vec{p} of the product to be classified or the word similarity between the frequency vector \vec{Hed} of the words that appear in the reviews of the hedonic product and the word vector \vec{p} of the product to be classified. For example, when the cosine similarity between the frequency vector \vec{Util} of the words that appear in the reviews of the utilitarian product and the word vector \vec{p} of the product to be classified is 0.7 and the cosine similarity between the frequency vector \vec{Hed} of the words that appear in the reviews of the hedonic product and the word vector \vec{p} of the product to be classified is 0.4, the corresponding product to be classified may be classified as a utilitarian product.

The classification unit 300 according to still another embodiment of the present invention may classify the type of a product using emotion words that appear in reviews of a product to be classified. To this end, the classification unit 300 may include an emotion index calculation unit 330 and the product type classification unit 350.

The emotion index calculation unit 330 may calculate an emotion index of the product to be classified for each emotion category.

Specifically, the emotion index calculation unit 330 may classify emotion expressing words into eleven emotion categories such as ‘sadness,’ ‘anger,’ ‘happiness,’ ‘surprise,’ ‘fear,’ ‘disgust,’ ‘boredom,’ ‘interest,’ ‘painful,’ ‘apathy,’ and ‘other’. Meanwhile, according to an embodiment of the present invention, the emotion categories of ‘apathy’ and ‘other’ can be excluded from the eleven emotion categories because they do not express emotions. At this point, an emotional strength may be matched for each of the emotion categories and stored. Meanwhile, a use probability of the emotion word is different for each of the emotion categories, and therefore there is a need to correct the emotional strength according to the use probability of the emotion word in the emotion categories. Accordingly, the emotion index calculation unit 330 may calculate the emotional strength of each of the emotion categories as the product of the use probability of the emotion word for each of the emotion categories and a predetermined strength. The emotion index calculation unit 330 may calculate the emotion index of the product to be classified using the emotional strength which has been calculated for each of the emotion categories. At this point, the emotion index calculation unit 330 may calculate the emotion index of the product to be classified by calculating the emotional strength for each of the emotion categories of emotion words that appear in the reviews of the product to be classified as a weighted average, and calculate the emotion index of the product to be classified through the following Equation 7.

$$EmotionScore ( p , c ) = \frac{{\sum }_{i = 1}^{\vert EW ( p ) \vert} f ( p , {ω}_{i} ) \times P ( c \text{\textbar} {ω}_{i} ) \times Intensity ( {ω}_{i ,} c )}{{\sum }_{i = 1}^{\vert EW ( p ) \vert} f ( p , {ω}_{i} )} \qquad [ Equation 7 ]$$

Here, EW (p) denotes a set of the emotion words that appear in reviews of a product to be classified p, EmotionScore(p,c) denotes an emotion index for an emotion category c of the product to be classified p, P(c|ωᵢ) denotes a probability that a word ωᵢ is used as the emotion category c, Intensity(ωᵢ, c) denotes the emotional strength when the word ωᵢ is used as the emotion category c, and f (p, ωᵢ) denotes an appearance frequency of the word ωᵢ in the reviews of the product to be classified p.

The emotion index calculation unit 330 according to another embodiment of the present invention may calculate an emotion index using an appearance frequency of a word whose appearance frequency has been corrected in order to prevent the type of a product from being wrongly classified due to the number of reviews of the utilitarian product or the hedonic product.

Specifically, the emotion index calculation unit 330 may calculate an emotional strength of each of the emotion categories as the product of the use probability of the emotion word for each of the emotion categories and a predetermined strength of the corresponding emotion category. The emotion index calculation unit 330 may calculate the emotion index of the product to be classified using the emotional strength which has been calculated for each of the emotion categories. At this point, the emotion index calculation unit 330 may calculate the emotion index of the product to be classified by calculating the emotional strength for each of the emotion categories of the words with corrected appearance frequencies which appear in the reviews of the product to be classified as a weighted average, and calculate the emotion index of the product to be classified through the following Equation 8.

$${EmotionScore }^{′} ( p , c ) = \frac{{\sum }_{i = 1}^{\vert EW ( p ) \vert} {f}^{′} ( p , {ω}_{i} ) \times P ( c \text{\textbar} {ω}_{i} ) \times Intensity ( {ω}_{i ,} c )}{{\sum }_{i = 1}^{\vert EW ( p ) \vert} {f}^{′} ( p , {ω}_{i} )} \qquad [ Equation 8 ]$$

Here, EW (p) denotes a set of emotion words that appear in reviews of a product to be classified p, EmotionScore′(p,c) denotes an emotion index using a corrected word frequency for an emotion category c of the product to be classified p, P(c|ωᵢ) denotes a probability that a word ωᵢ is used as the emotion category c, Intensity(ωᵢ, c) denotes the emotional strength when the word ωᵢ is used as the emotion category c, and f′(p, ωᵢ) denotes a corrected appearance frequency of the word ωᵢ in the reviews of the product to be classified p.

An example in which an emotion index is calculated for each product and each emotion category by the emotion index calculation unit 330 is shown in the following Table 3.

TABLE 3

| | Products | | | |
|---|---|---|---|---|
| | Utilitarian product | | Hedonic product | |
| Emotions | Spark | Sonata hybrid | Audi R8 | Genesis coupe |
| Sadness | 2.593 | 4.375 | 5.295 | 2.345 |
| Anger | 0.865 | 0.766 | 2.028 | 0.834 |
| Happiness | 0.136 | 0.513 | 2.582 | 0.443 |
| Surprise | 0.471 | 0.608 | 1.433 | 0.71 |
| Fear | 1.158 | 1.919 | 5.75 | 1.462 |
| Disgust | 3.088 | 3.382 | 4.567 | 3.088 |
| Boredom | 2.661 | 4.947 | 0 | 2.665 |
| Interest | 0.284 | 0.1 | 3.683 | 0.249 |
| Painful | 0.461 | 0.389 | 5.626 | 0.416 |

Here, the product type classification unit 350 may classify the type of the product to be classified using the emotion index calculated by the emotion index calculation unit 330. At this point, the product type classification unit 350 may classify the type of the product using the emotion index through machine learning. To this end, the product type classification unit 350 may extract an emotion word from reviews collected by the collection unit 100, calculate an emotion index of the extracted emotion word for each of the emotion categories to generate training data, and classify the generated training data for each of the emotion categories through machine learning.

Meanwhile, as described above, the type of the product may be classified in each classification method using the calculated utilitarian and hedonic index of the product, the word similarity, or the emotion index, but when the type of the product is classified based on an arbitrary criterion, an error may occur and there is a difficulty in finding an optimal classification criterion. Thus, as a method for reducing an error, an optimal classification criterion may be required to be found to generate a classification model.

Accordingly, the classification unit 300 according to still another embodiment of the present invention may classify the type of a product to be classified by combining a utilitarian and hedonic index of the product to be classified, a word similarity, and an emotion index, which are features of the product to be classified. To this end, the classification unit 300 according to still another embodiment of the present invention may include a feature combination unit 340 and a product type classification unit 350. At this point, the classification unit 300 according to still another embodiment of the present invention may adopt the best algorithm among a decision tree algorithm, a support vector machine algorithm, and a logistic regression algorithm through experimentation for the purpose of classification, and generate a classification model using the adopted algorithm, thereby classifying the type of a product.

The feature combination unit 340 may recognize each of the utilitarian and hedonic index of the product to be classified, a utilitarian product similarity, a hedonic product similarity, and nine emotion indexes (‘sadness’, ‘anger’, ‘happiness’, ‘surprise’, ‘fear’, ‘disgust’, ‘boredom’, ‘interest’, and ‘painful’) as one feature. The feature combination unit 340 may combine two or more features. At this point, the feature combination unit 340 may calculate a feature importance for each domain, and select a feature according to the calculated feature importance to combine features. At this point, the feature combination unit 340 may determine the feature for each domain through machine learning. The feature combination unit 340 may generate a classification model to combine the features of the product to be classified according to feature combination data determined in advance for each domain.

First, the feature combination unit 340 may calculate the accuracy of the classification of a training algorithm for each of the features in order to adopt a training algorithm for generating the classification model. At this point, the feature combination unit 340 may separate reviews collected for each domain into training data and test data. Meanwhile, when the number of products is small for each domain, there is a problem in that it is difficult to separate the training data and the test data, and therefore the feature combination unit 340 according to an embodiment of the present invention may use a leave-one-out cross validation method. At this point, the leave-one-out cross validation method performs an n-fold cross validation when n pieces of data exist, and the cross validation may be performed by establishing a training data set using n−1 pieces of data and a test data set using the remaining piece of data. At this point, the test data is selected one by one, and therefore the validation may be performed a total of n times and the accuracy of the validation may be calculated as an average of the accuracy of the validation which has been performed n times.

For example, in a case of a car domain, the training data set may be established using 29 pieces of data among a total 30 pieces of data and trained, and validation may be performed using the remaining one piece of data so that training and validation may be performed 30 times. The accuracy of the classification model may be calculated by the following Equation 9, and validation may be performed using an average of the accuracy which has been calculated 30 times.

$$Accuracy = \frac{TP + TN}{TP + FP + TN + FN} \qquad [ Equation 9 ]$$

Here, the accuracy of the classification may be calculated by dividing a sum of TP (a true positive number) and TN (a true negative number), which are correctly classified, by the total number of pieces of data as shown in Equation 9.

Based on the result of calculating the accuracy of the classification for each training algorithm for each of the features in FIG. 2, it can be seen that the support vector machine algorithm shows the highest accuracy in the features of ‘utilitarian/hedonic dictionary’ and ‘emotion index’, and the decision tree algorithm shows the highest accuracy in the feature of ‘word similarity’. Accordingly, the feature combination unit 340 may adopt the support vector machine algorithm as the training algorithm for the features of ‘utilitarian/hedonic dictionary’ and ‘emotion index’ and adopt the decision tree algorithm as the training algorithm for the feature of ‘word similarity.’ The feature combination unit 340 may calculate a feature importance for each domain using the adopted training algorithm. The feature combination unit 340 may select the feature according to the order of the feature importance for each domain, and derive the number of optimal features when the features are combined. At this point, how many high-order features should be used to show the best performance may be determined based on the importance results in a manner such that the accuracy of the feature combination may be measured using the support vector machine algorithm based on a corrected appearance frequency of a corresponding word and the optimal number of features may be derived when the features are combined.

For example, in the car domain, when a classification model is generated by selecting three high-order features in terms of importance (the utilitarian and hedonic index, the utilitarian product similarity, and the emotion index of boredom) based on results of the combination of the features, a highest accuracy of 73.33% may be shown. Accordingly, the feature combination unit 340 may generate the classification model for the feature combination by combining the utilitarian and hedonic index, the utilitarian product similarity, and the emotion index of boredom. In addition, in a case of a hotel domain, when a classification model is generated by selecting three high-order features in terms of importance (the utilitarian and hedonic index, the hedonic product similarity, and the emotion index of happiness), a highest accuracy of 69% may be shown. Accordingly, the feature combination unit 340 may generate the classification model for the feature combination by combining the utilitarian and hedonic index, the hedonic product similarity, and the emotion index of happiness. In addition, in a case of a watch domain, when a classification model is generated by selecting five high-order features in terms of importance (the utilitarian and hedonic index, the hedonic product similarity, the utilitarian product similarity, the emotion index of interest, and the emotion index of surprise), a highest accuracy of 93.1% may be shown. Accordingly, the feature combination unit 340 may generate the classification model for the feature combination by combining the utilitarian and hedonic index, the hedonic product similarity, the utilitarian product similarity, the emotion index of interest, and the emotion index of surprise in the watch domain.

The product type classification unit 350 may classify the type of the product to be classified using the classification model generated by the feature combination unit 340.

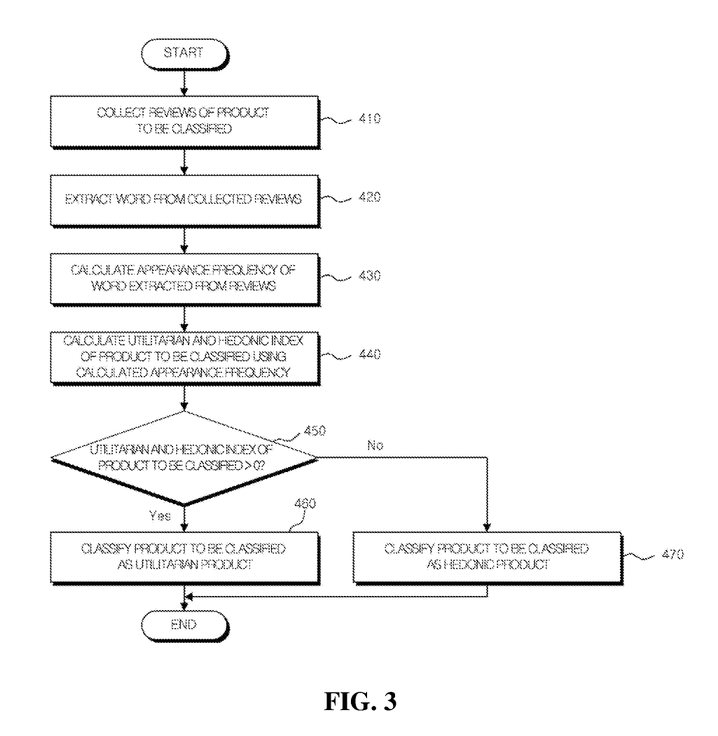

Hereinafter, a method for classifying a product type using a utilitarian and hedonic index according to an embodiment of the present invention will be described with reference to FIG. 3.

First, the method collects reviews of a product to be classified using a collection unit in operation S410 and extracts a word from the collected reviews in operation S420.

At this point, the extracting of the word from the reviews may extract a frequently occurring word by morphologically analyzing the reviews in units of sentences as described above.

The method calculates an appearance frequency of the word that indicates the number of times that the word extracted from the reviews appears in the reviews in operation S430, and calculates a utilitarian and hedonic index of the product to be classified using the calculated appearance frequency in operation S440.

At this point, the calculating of the utilitarian and hedonic index of the product to be classified may calculate the utilitarian and hedonic index of the product to be classified using the appearance frequency of the word included in the reviews of the product to be classified and a utilitarian/hedonic dictionary generated in advance, as described above.

The method determines whether the calculated utilitarian and hedonic index of the product to be classified exceeds a predetermined threshold value, that is, 0, in operation S450, classifies the product to be classified as a utilitarian product when the utilitarian and hedonic index of the product to be classified exceeds 0 in operation S460, and classifies the product to be classified as a hedonic product when the utilitarian and hedonic index of the product to be classified is 0 or less in operation S470.

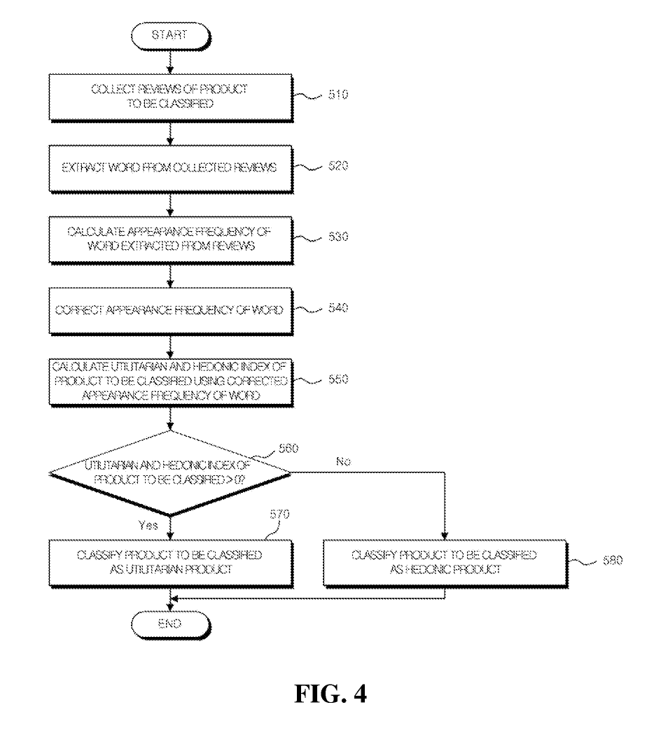

Hereinafter, a method for classifying a product type using a utilitarian and hedonic index according to another embodiment of the present invention will be described with reference to FIG. 4.

First, the method collects reviews of a product to be classified using a collection unit in operation S510, and extracts a word from the collected reviews in operation S520.

The method calculates an appearance frequency of the word that indicates the number of times that the word extracted from the reviews appears in the reviews in operation S530, and, in order to minimize a probability that the type of the product may be wrongly classified due to a characteristic in which the number of words that appear in reviews of a utilitarian product is generally larger than the number of words that appear in reviews of a hedonic product, corrects the appearance frequency of the word extracted from the reviews in operation S540.

At this point, the correcting of the appearance frequency of the word may be performed according to the above-described Equation 1.

The method calculates a utilitarian and hedonic index of the product to be classified using the corrected appearance frequency of the word in operation S550.

The method determines whether the calculated utilitarian and hedonic index of the product to be classified exceeds a predetermined threshold value, that is, 0, in operation S560, classifies the product to be classified as a utilitarian product when the utilitarian and hedonic index of the product to be classified exceeds 0 in operation S570, and classifies the product to be classified as a hedonic product when the utilitarian and hedonic index of the product to be classified is 0 or less in operation S580.

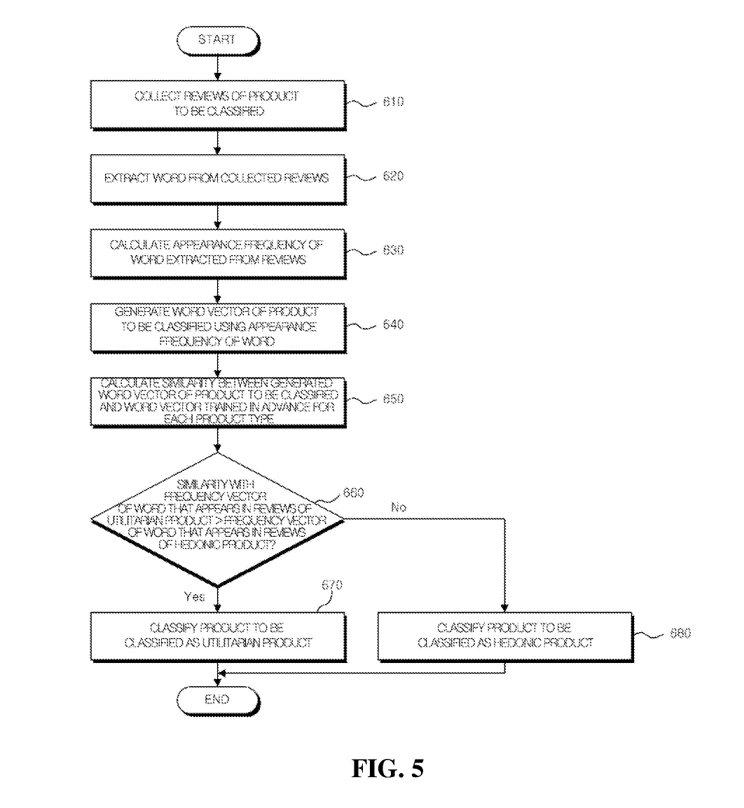

Hereinafter, a method for classifying a product type using word similarity according to an embodiment of the present invention will be described with reference to FIG. 5.

First, the method collects reviews of a product to be classified using a collection unit in operation S610, and extracts a word from the collected reviews in operation S620.

The method calculates an appearance frequency of the word that indicates the number of times that the word extracted from the reviews appears in the reviews in operation S630, and generates a word vector of the product to be classified using the calculated appearance frequency in operation S640.

At this point, the generating of the word vector of the product to be classified may generate the word vector of the product to be classified by calculating an appearance frequency of each of a plurality of words extracted from the reviews and matching the word and the calculated appearance frequencies.

The method calculates a similarity between the generated word vector of the product to be classified and a word vector trained in advance for each product type in operation S650.

At this point, the calculating of the similarity between the word vector of the product to be classified and the word vector trained in advance for each product type may calculate a cosine similarity between the word vector of the product to be classified and the word vector trained in advance for a utilitarian product and calculate a cosine similarity between the word vector of the product to be classified and the word vector trained in advance for a hedonic product.

The method determines whether the similarity between the word vector of the product to be classified and the word vector trained in advance for a utilitarian product is larger than the similarity between the word vector of the product to be classified and the word vector trained in advance for a hedonic product in operation S660, classifies the product to be classified as a utilitarian product when the similarity between the word vector of the product to be classified and the word vector trained in advance for a utilitarian product is larger than the similarity between the word vector of the product to be classified and the word vector trained in advance for a hedonic product in operation S670, and otherwise classifies the product to be classified as a hedonic product in operation S680.

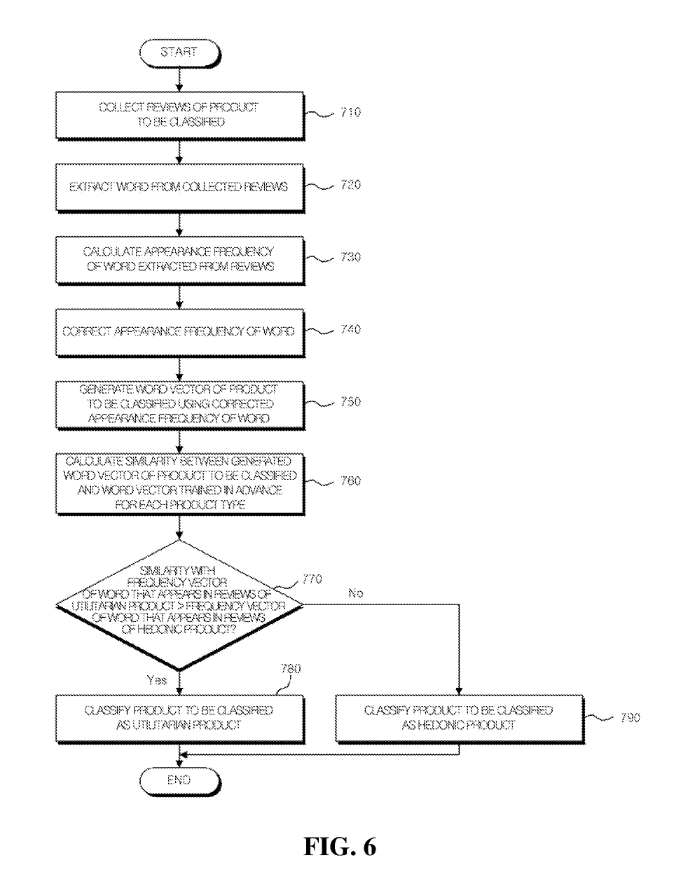

Hereinafter, a method for classifying a product type using a utilitarian and hedonic index according to another embodiment of the present invention will be described with reference to FIG. 6.

First, the method collects reviews of a product to be classified using a collection unit in operation S710, and extracts a word from the collected reviews in operation S720.

The method calculates an appearance frequency of the word that indicates the number of times that the word extracted from the reviews appears in the reviews in operation S730, and, in order to minimize a probability that the type of the product may be wrongly classified due to a characteristic in which the number of words that appear in reviews of a utilitarian product is generally larger than the number of words that appear in reviews of a hedonic product, corrects the appearance frequency of the word extracted from the reviews in operation S740.

The method generates a word vector of the product to be classified using the corrected appearance frequency of the word in operation S750.

At this point, the generating of the word vector of the product to be classified may generate the word vector of the product to be classified by calculating an appearance frequency of each of a plurality of words extracted from the reviews and matching the word and the calculated appearance frequency.

The method calculates a similarity between the generated word vector of the product to be classified and a word vector trained in advance for each product type in operation S760.

At this point, the calculating of the similarity between the word vector of the product to be classified and the word vector trained in advance for each product type may calculate a cosine similarity between the word vector of the product to be classified and the word vector trained in advance for a utilitarian product and calculate a cosine similarity between the word vector of the product to be classified and the word vector trained in advance for a hedonic product.

The method determines whether the similarity between the word vector of the product to be classified and the word vector trained in advance for a utilitarian product is larger than the similarity between the word vector of the product to be classified and the word vector trained in advance for a hedonic product in operation S770, classifies the product to be classified as a utilitarian product when the similarity between the word vector of the product to be classified and the word vector trained in advance for a utilitarian product is larger than the similarity between the word vector of the product to be classified and the word vector trained in advance for a hedonic product in operation S780, and otherwise classifies the product to be classified as a hedonic product in operation S790.

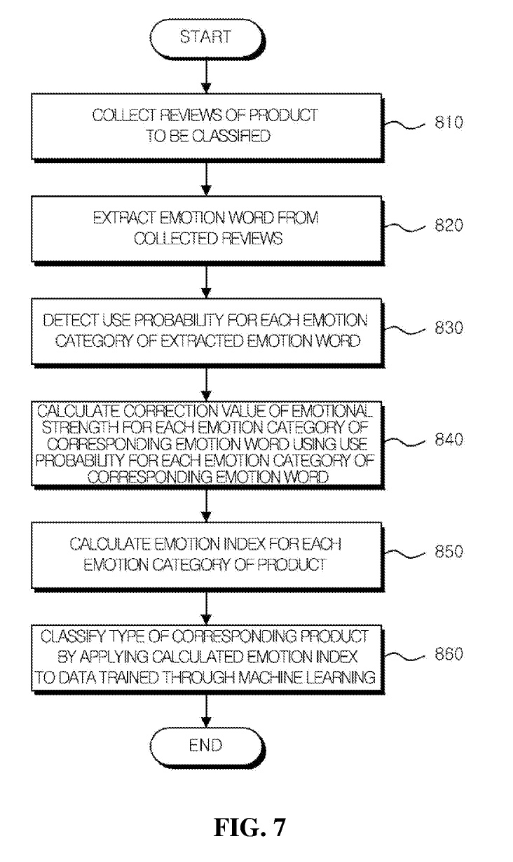

Hereinafter, a method for classifying a product type using an emotion index according to an embodiment of the present invention will be described with reference to FIG. 7.

First, the method collects reviews of a product to be classified using a collection unit in operation S810, extracts an emotion word from the collected reviews in operation S820, and detects a use probability of the emotion word that indicates the number of times the emotion word extracted from the reviews is used for each of emotion categories in operation S830.

At this point, the use probability of the emotion word for each of emotion categories may be a value that is classified for each of the emotion categories and stored in advance.

The method calculates a correction value of an emotional strength of a corresponding emotion word for each of the emotion categories using the use probability for each of the emotion categories of the detected corresponding emotion word in operation S940.

At this point, the calculating of the correction value of the emotional strength of the corresponding emotion word for each of the emotion categories may correct the emotional strength of the emotion word according to the emotion categories and thereby calculate a more accurate emotion index because the emotion word may belong to various emotion categories and the emotional strength indicated by the corresponding emotion word may vary according to which emotion category the emotion word belongs to. For example, an emotion word of ‘nervous’ may have a use probability of 0.413 in the emotion category of fear, and the emotion word of ‘nervous’ may originally have the emotional strength of 4.72 but have a correction value of the emotional strength of 1.949(0.413 □4.72=1.949) in the emotion category of fear.

The method calculates the correction value of the emotional strength of a corresponding emotion word for each of the emotion categories in operation S840, and then calculates an emotion index for each of the emotion categories of the product using the correction value of the emotional strength of the corresponding emotion word for each of the emotion categories and the appearance frequency of the corresponding emotion word that appears in the reviews in operation S850.

At this point, the emotion index for each of the emotion categories of the product may be calculated through Equation 7 as described above.

The method classifies the type of the corresponding product by applying the calculated emotion index for each of the emotion categories of the product to data trained through machine learning in operation S860.

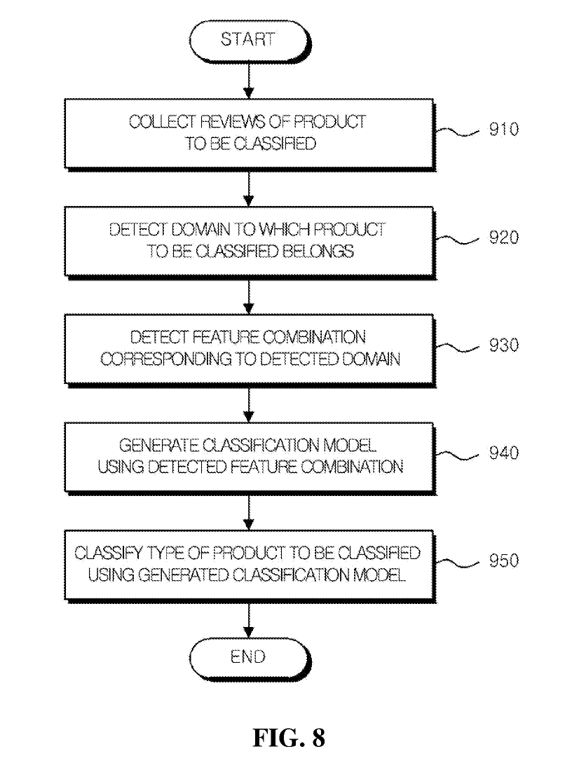

Hereinafter, a method for classifying a product type using a feature combination according to another embodiment of the present invention will be described with reference to FIG. 8.

First, the method collects reviews of a product to be classified using a collection unit in operation S910.

After collecting the reviews in operation S910, the method detects a domain to which the product to be classified belongs in operation S920, and detects a feature combination corresponding to the detected domain in operation S930.

At this point, as to the feature combination, a training importance for each domain may be calculated using a training algorithm adopted for each domain as described above, and the feature combination may be detected from feature combination data for each domain detected by deriving the number of optimal features according to the calculated training importance.

After detecting the feature combination in operation S930, the method generates a classification model according to the detected feature combination in operation S940, and classifies the type of the product to be classified using the generated classification model in operation 5950.

As described above, according to an embodiment of the present invention, it is possible to more objectively classify a type of a corresponding product by calculating an index capable of determining the type of the corresponding product using words included in reviews of the product.

The technology for classifying the type of the product may be implemented as an application or implemented in the form of program instructions that may be executed in various computer components and recorded on a computer-readable recording medium. The computer-readable recording medium may include program instructions, data files, data structures, and the like individually or in a combination.

The program instructions recorded on the medium may be specifically designed and constructed for the present invention, and may be made publicly available to and useable by those having ordinary skill in the art of the computer software.

Examples of the computer-readable recording medium include a magnetic medium such as a hard disk, a floppy disk, or a magnetic tape, an optical recording medium such as a compact disc-read only memory (CD-ROM) or a digital video disc (DVD), a magneto-optical medium such as a floptical disk, and a hardware device such as ROM, a random access memory (RAM), or a flash memory that is specially designed to store and execute program instructions.

Examples of the program instructions include not only a machine code generated by a compiler or the like but also high-level language codes that may be executed by a computer using an interpreter or the like. The hardware device described above may be constructed so as to operate as one or more software modules for performing the operations of the embodiments of the present invention, and vice versa.

While the invention has been shown and described with reference to certain exemplary embodiments thereof, it should be understood by those skilled in the art that various changes in form and details may be made therein without departing from the spirit and scope of the invention as defined by the appended claims.

1-12. (canceled)

13. A method for product type classification, the method comprising:
collecting reviews of a product;
extracting words from the collected reviews;
computing an appearance frequency for each of the extracted words;
calculating an index for said product using the computed appearance frequencies for the extracted words; and
classifying said product based on the calculated index,
wherein the index for said product is a utilitarian and hedonic index, a word similarity index, or an emotion index.

14. The method for product type classification of claim 13, wherein the index for said product is a utilitarian and hedonic index.

15. The method for product type classification of claim 14, wherein the calculating a utilitarian and hedonic index for said product comprises:
building a utilitarian/hedonic dictionary;
extracting a utilitarian and hedonic index for each of the extracted words from the utilitarian/hedonic dictionary; and
calculating the utilitarian and hedonic index for said product using the extracted utilitarian and hedonic indices and computed appearance frequencies for the extracted words.

16. The method for product type classification of claim 15, wherein the building a utilitarian/hedonic dictionary comprises:
calculating a probability that an arbitrary word would appear in reviews of a utilitarian product, and
calculating a probability that an arbitrary word would appear in reviews of a hedonic product.

17. The method for product type classification of claim 15, wherein:
the extracting a utilitarian and hedonic index for each of the extracted words has a value of −1.0 to 1.0,
when the utilitarian and hedonic index of the word is larger than 0, the corresponding word is recognized as a utilitarian word, and
when the utilitarian and hedonic index of the word is equal to or less than 0, the corresponding word is recognized as a hedonic word.

18. The method for product type classification of claim 15, wherein the classifying said product based on the calculated utilitarian and hedonic index comprises:
classifying said product as a utilitarian product when the utilitarian and hedonic index exceeds a predetermined threshold value, and
classifying said product as a hedonic product when the utilitarian and hedonic index is equal to or less than the predetermined threshold value.

19. The method for product type classification of claim 13, wherein the index for said product is a word similarity index.

20. The method for product type classification of claim 19, wherein the calculating a word similarity index for said product comprises:
preparing a word frequency vector of a utilitarian product,
preparing a word frequency vector of a hedonic product,
generating a word frequency vector for said product using the computed appearance frequencies for the extracted words,
calculating a first cosine similarity between the generated word frequency vector for said product and the word frequency vector of a utilitarian product, and
calculating a second cosine similarity between the generated word frequency vector for said product and the word frequency vector of a hedonic product.

21. The method for product type classification of claim 19, wherein the classifying said product based on the calculated word similarity index comprises:
classifying said product as a utilitarian product when the first cosine similarity is larger than the second cosine similarity, and
classifying said product as a hedonic product when the first cosine similarity is less than the second cosine similarity.

22. The method for product type classification of claim 13, wherein the index for said product is an emotion index.

23. The method for product type classification of claim 22, wherein the calculating an emotion index for said product comprises:
identifying an emotion category of each of the extracted words,
computing an emotional strength corresponding to the identified emotion category, and
calculating the emotion index for said product using the computed emotional strength.

24. The method for product type classification of claim 23, wherein the computing an emotional strength corresponding to the identified emotion category comprises:
collecting use probability data for a list of emotion categories,
preparing a use probability for each emotion category based on the collected use probability data,
extracting an emotional strength corresponding to the identified emotion category from the prepared use probabilities for emotion categories, and
correcting the emotional strength corresponding to the identified emotion category using the prepared use probabilities for emotion categories.

25. The method for product type classification of claim 23, wherein the calculating the emotion index for said product using the computed emotional strength comprises using the computed emotional strength, the appearance frequency for each emotion category, and a weighted average of the use probability for each emotion category.

26. The method for product type classification of claim 23, wherein the classifying said product using the calculated emotion index comprises:
collecting reviews for a plurality of products,
generating training data capable of classifying the type of said product according to the emotion index on the collected reviews for the plurality of products, and
applying the emotion index for said product to the training data, thereby classifying said product.

27. The method for product type classification of claim 26, wherein the generating training data capable of classifying the type of said product according to the emotion index on the collected reviews for the plurality of products comprises use of machine learning.

28. The method for product type classification of claim 13, further comprising:
detecting a domain to which said product belongs,
detecting feature combination information corresponding to the domain to which said product belongs from feature combination data for each domain stored in advance,
generating a classification model for said product according to the detected feature combination information, and
classifying said product using the classification model for said product.

29. The method for product type classification of claim 28, wherein the detecting feature combination information corresponding to the domain to which said product belongs from feature combination data for each domain stored in advance comprises use of machine learning.

30. The method for product type classification of claim 13, wherein the computing an appearance frequency for each of the extracted words comprises correcting the appearance frequency of the word using a ratio of the number of times the word appears in the reviews to the number of all words that appear in the reviews in order to minimize an error factor caused by a difference in the number of words that appear in reviews of a utilitarian product and a hedonic product.

31. An apparatus for product type classification comprising:
a collection unit that collects reviews of a product to be classified;
a pre-processing unit that extracts a word from the reviews and computes an appearance frequency for the extracted word; and
a classification unit that calculates an index for said product using the computed appearance frequencies for the extracted words, and classifies said product according to the calculated index for said product.

32. The apparatus for product type classification of claim 19, wherein the index for said product is a utilitarian and hedonic index, a word similarity index, or an emotion index.
